(19) United States
(12) Patent Application Publication
(10) Pub. No.: US 2010/0106342 A1
(43) Pub. Date: Apr. 29, 2010

(54) DAY-AHEAD LOAD REDUCTION SYSTEM BASED ON CUSTOMER BASELINE LOAD

(75) Inventors: Jong-Min KO, Daejeon (KR); Nam-Joon JUNG, Daejeon (KR); In-Hyeob YU, Daejeon (KR); Young-Il KIM, Daejeon (KR)

Correspondence Address: THE NATH LAW GROUP, 112 South West Street, Alexandria, VA, 22314, US

(73) Assignee: KOREA ELECTRIC POWER CORPORATION, Gangnam-gu (KR)

(21) Appl. No.: 12/576,609

(22) Filed: Oct. 9, 2009

(30) Foreign Application Priority Data
Oct. 28, 2008 (KR) 10-2008-0106162

(51) Int. Cl. G06F 19/00

(52) U.S. Cl. 700/295

(57) ABSTRACT

Provided is a day-ahead load reduction system based on a customer baseline load for inducing a user to efficiently manage energy consumption by applying an incentive (user compensation according to load reduction) to achieve load reduction and load decentralization. The day-ahead load reduction system based on a customer baseline load operates in connection with a provider terminal and a user terminal through a network to induce a reduction in the load of a user and includes an AMI/AMR translator collecting load profile data of the user in real time, converting the load profile data and storing the load profile data in a meter data warehouse; a meter data management system monitoring and analyzing the load profile data stored in the meter data warehouse in real time; a demand response operation system managing the demand of the user by using the load profile data and performing overall management, analysis and verification of a day-ahead load reduction event; a customer energy management system operating in connection with the demand response operation system and providing information on the load to the user through the user terminal in real time to allow the user to control the load; and an account system operating in connection with the demand response operation system and the customer energy management system, calculating an incentive for the day-ahead load reduction event and notifying a provider and the user of the incentive through the provider terminal and the user terminal.

### CROSS REFERENCE TO RELATED APPLICATION

This application claims priority from and the benefit of Korean Patent Application No. 10-2008-0106162, filed on Oct. 28, 2008, which is hereby incorporated by reference for all purposes as if fully set forth herein.

### BACKGROUND OF THE INVENTION

1. Field of the Invention

The present invention relates to a day-ahead load reduction system based on a customer baseline load for inducing a user to efficiently manage energy consumption by applying an incentive (user compensation according to load reduction) to achieve load reduction and load decentralization.

2. Discussion of the Related Art

At present, an electric power corporation (electric power provider) not only supplies electricity to a customer (user) but also provides various electric power additional information services such as remote metering, demand management and rate system through an electric power additional information system connected to a network installed between the electric power corporation and the customer.

A conventional electric power additional information system is operated according to supply-oriented demand management (that is, supply-oriented demand side management policy) in such a manner that an electric power corporation directly controls a load in order to move or reduce a peak load (electric consumption) during the summer according to a plan of generation of electric power and transmission and distribution of electric power or arbitrarily or attempts to decentralize the load according to hourly flat rate without using a yearly load reduction technique according to a market price variation.

The conventional electric power additional information system cannot induce efficient energy consumption management of customers because the conventional electric power additional information system is operated by the supply-oriented demand side management policy, as described above.

Accordingly, there is required a system capable of providing services to induce customers to actively consume energy to achieve efficient energy consumption management of the customers.

### SUMMARY OF THE INVENTION

This invention provides a day-ahead load reduction system based on a customer baseline load for inducing a user to efficiently manage energy consumption by applying an incentive (user compensation according to load reduction) to achieve load reduction and load decentralization.

In an exemplary embodiment, a day-ahead load reduction system based on a customer baseline load, which operates in connection with a provider terminal and a user terminal through a network to induce a reduction in the load of a user, includes an AMI/AMR translator collecting load profile data of the user in real time, converting the load profile data and storing the load profile data in a meter data warehouse; a meter data management system monitoring and analyzing the load profile data stored in the meter data warehouse in real time; a demand response operation system managing the demand of the user by using the load profile data and performing overall management, analysis and verification of a day-ahead load reduction event; a customer energy management system operating in connection with the demand response operation system and providing information on the load to the user through the user terminal in real time to allow the user to control the load; and an account system operating in connection with the demand response operation system and the customer energy management system, calculating an incentive for the day-ahead load reduction event and notifying a provider and the user of the incentive through the provider terminal and the user terminal.

The load may correspond to the amount of electric power used, the day-ahead load reduction event may be an event regarding a reduction in the load, which is provided by the provider, and the incentive may correspond to compensation per kW of the load reduction, which is provided to the user.

The demand response operation system may include a demand response (DR) customer management managing a contract of a user who will participate in the day-ahead load reduction event and operation of a procedure; a DR event management registering the day-ahead load reduction event and notifying the user of the day-ahead load reduction event in advance by using the user terminal; a DR event execution management executing the day-ahead load reduction event and managing the execution of the day-ahead load reduction event; and a DR event analysis and validation management performing analysis and validation on the effect of the day-ahead load reduction event.

The DR customer management may perform comparison and analysis of day-ahead load reduction resources and the overall power resources by administrative districts for the status of joining of users in the day-ahead load reduction event.

The DR event management may register a new day-ahead load reduction event, inquire into the status of participation of users in the registered new day-ahead load reduction event, analyze the status of participation of users in a day-ahead load reduction event that is being executed, and perform analysis of the effect of user's participation in an ended day-ahead load reduction event.

The DR event execution management may monitor and analyze the execution of the day-ahead load reduction event of the user in real time and analyze the status of participation of the user for the administrative district, contract power and class of contract with respect to the user.

The DR event analysis and validation management may analyze and verify the effect of the ended day-ahead load reduction event to perform comparison and analysis of the customer baseline load and the actual amount of electric power used by administrative districts, classes of contract and contract power of users participating in the day-ahead load reduction event and synthetically manage CO₂ reduced emission and a reduction with respect to the use of electric power.

The customer energy management system may include an event management performing contract, agreement approval, facility information management, determination whether or not to execute and history inquiry with respect to the day-ahead load reduction event; an event processor approving participation in the notified day-ahead load reduction event and performing real-time monitoring; an event analyzer analyzing the effect of participation in the executed day-ahead load reduction event; and a load operating simulation performing load facility management, load operating scenario management, establishment of a daily load operating plan, management of weekly/monthly load operating plans, and a load operating plan simulation.

The event processor may monitor CO₂ reduced emission and a reduction with respect to the use of electric power, the change in maximum acceptance and the change in the amount of electric power used by loads, control a selected load facility according to a load operating plan of the user through the user terminal, and monitor the voltage, current, frequency, total harmonics distortion (THD) of the load facility.

The event analyzer may provide the customer baseline load, the amount of electric power reduced, the incentive, CO₂ reduced emission with respect to the use of electric power and weather information to the user through the user terminal during the day-ahead load reduction event and perform comparison and analysis of the customer baseline load and the actual amount of electric power used at predetermined intervals.

The load operating simulation may establish and manage a facility operating plan according to the power facility operating status of the user for the registered load facility.

The day-ahead load reduction system based on a customer baseline load may further include a load forecasting analysis system interface operating in connection with a day-ahead load forecasting analysis system which executes the day-ahead load reduction event, analyzes the effect of the day-ahead load reduction event and calculates a customer baseline load that will be applied to settlement to provide the customer baseline load to the demand response operation system.

The day-ahead load reduction system based on a customer baseline load may further include an energy information agent interface providing energy data from an energy information agent system which performs scheduling for collecting the energy data from different types of networks and systems, and extracting, changing and loading an extract transform load (ETL) to the demand response operation system in real time.

The day-ahead load reduction system based on a customer baseline load according to the present invention can control the load of a customer at regular times by applying an incentive (customer compensation according to load reduction) to induce the customer to manage efficient energy consumption.

According to the day-ahead load reduction system based on a customer baseline load according to the present invention, a provider (electric power corporation) can reduce the purchase electric power price according to a drop in wholesale electric power price caused by a load reduction and a user (customer) can cost-flexibly consume electric power through the incentive, change the habit of using electric power at the power peak and reduce power consumption.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention.

FIG. 1 is a block diagram of a day-ahead load reduction system based on a customer baseline load according to an embodiment of the present invention;

FIG. 2, FIG. 4 and FIGS. 6 through 8 are exemplary views for showing the function of a demand response operation system illustrated in FIG. 1;

FIG. 3 is a flow chart for showing application and approval for the DR event;

FIG. 5 is a flow chart for showing the demand response operation and the energy management system; and

FIGS. 9 through 15 are exemplary views for showing the function of a customer energy management system illustrated in FIG. 1.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather these embodiments are provided so that this disclosure is thorough, and will fully convey the scope of the invention to those skilled in the art.

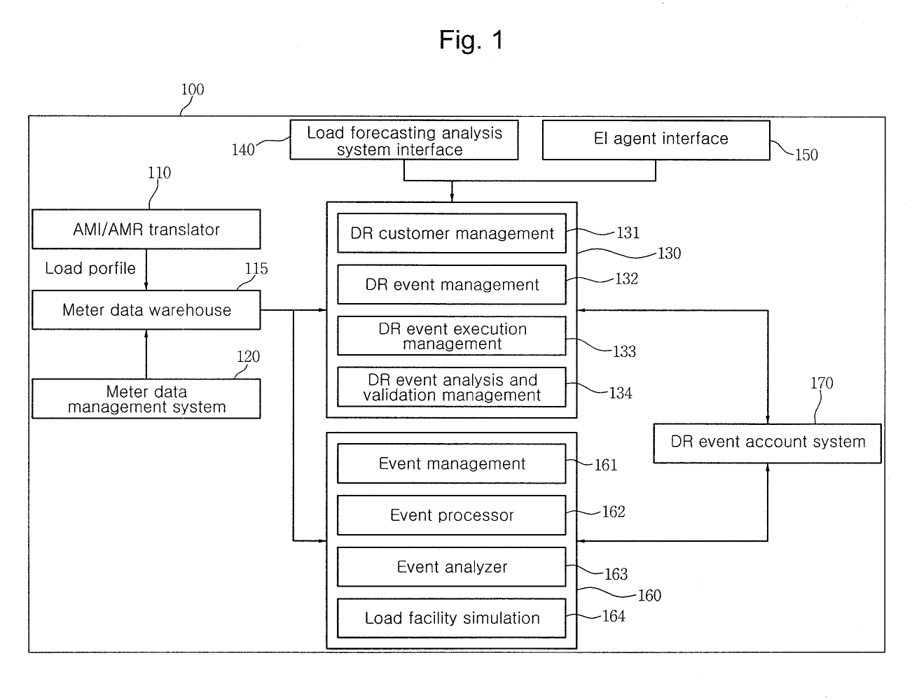

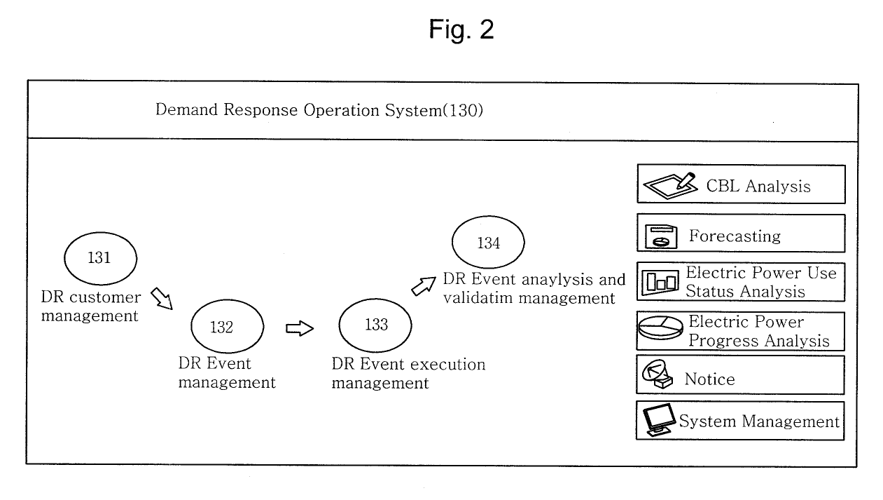

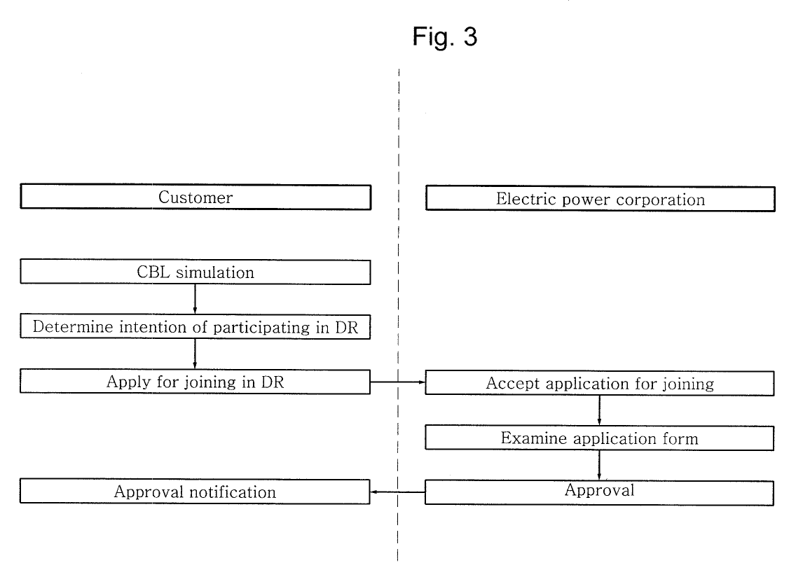

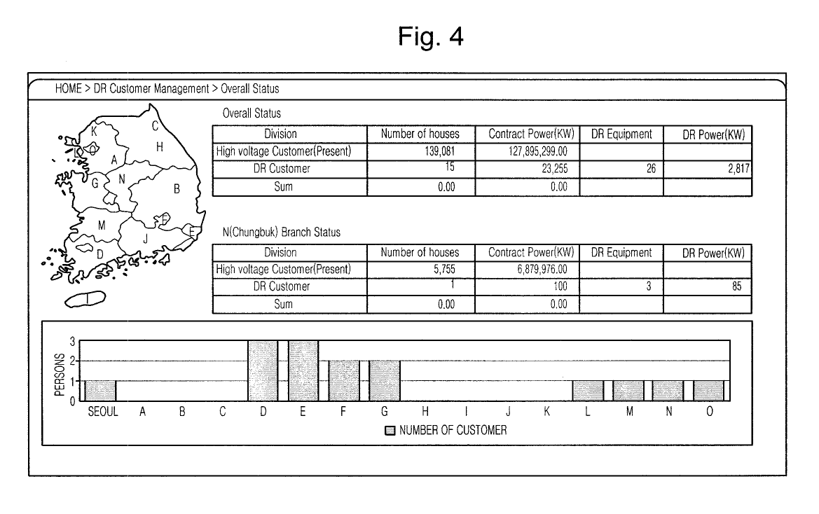

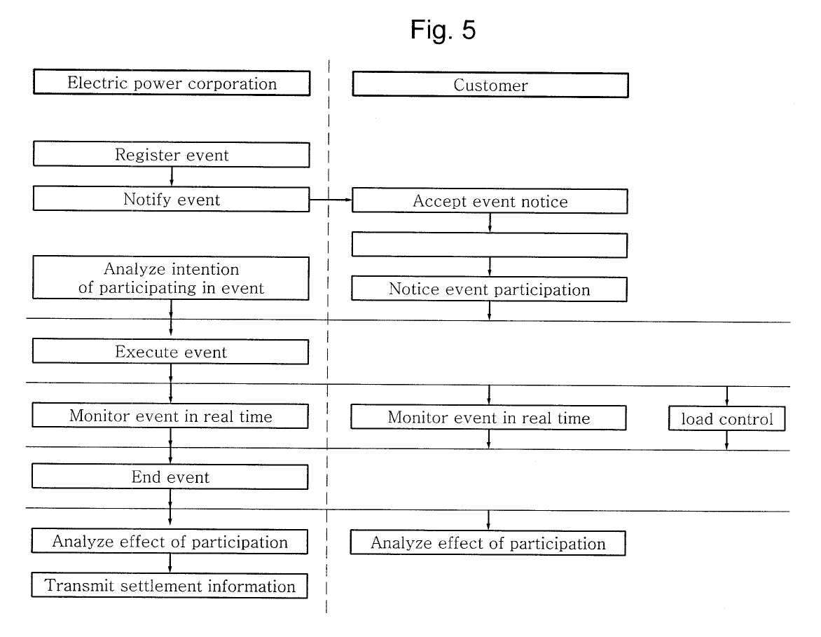

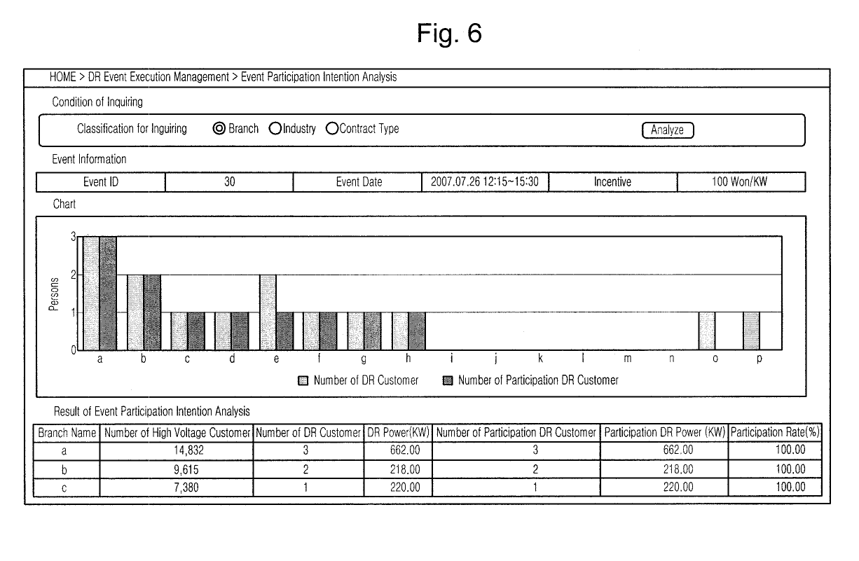

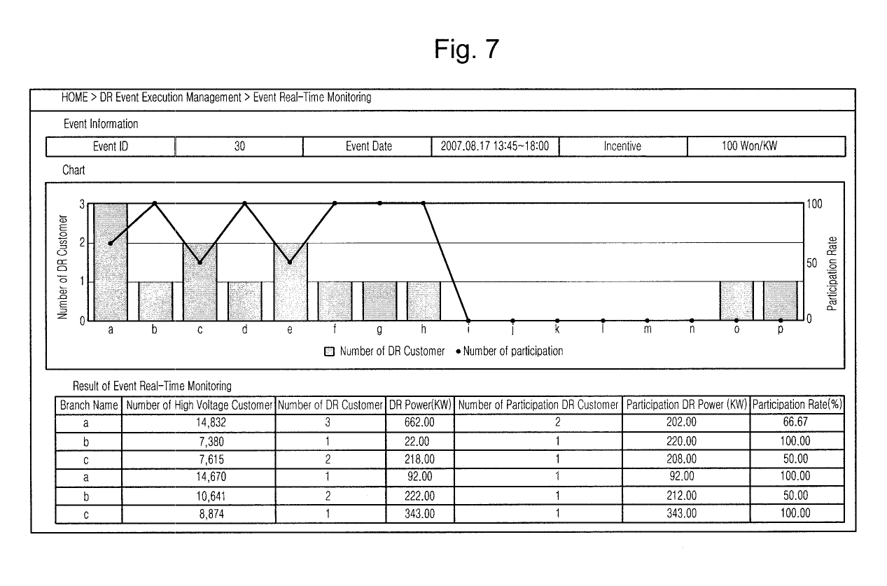

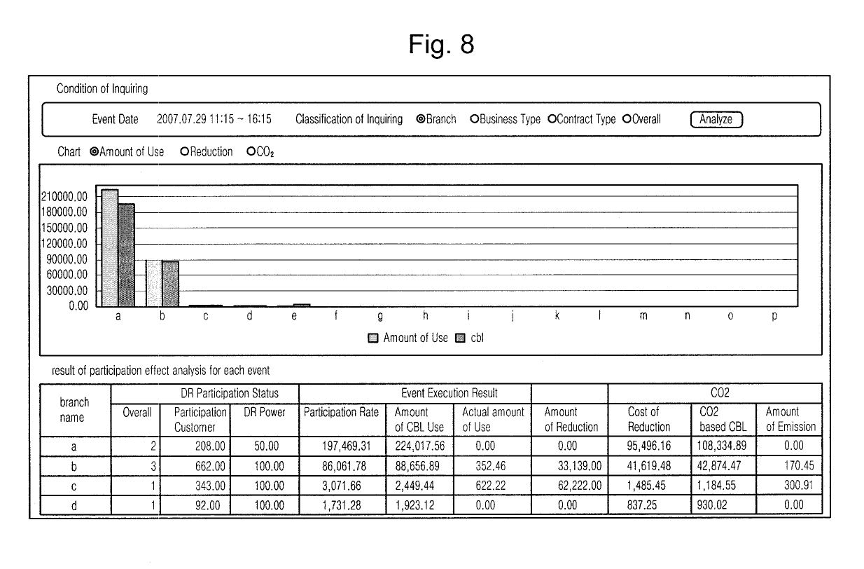

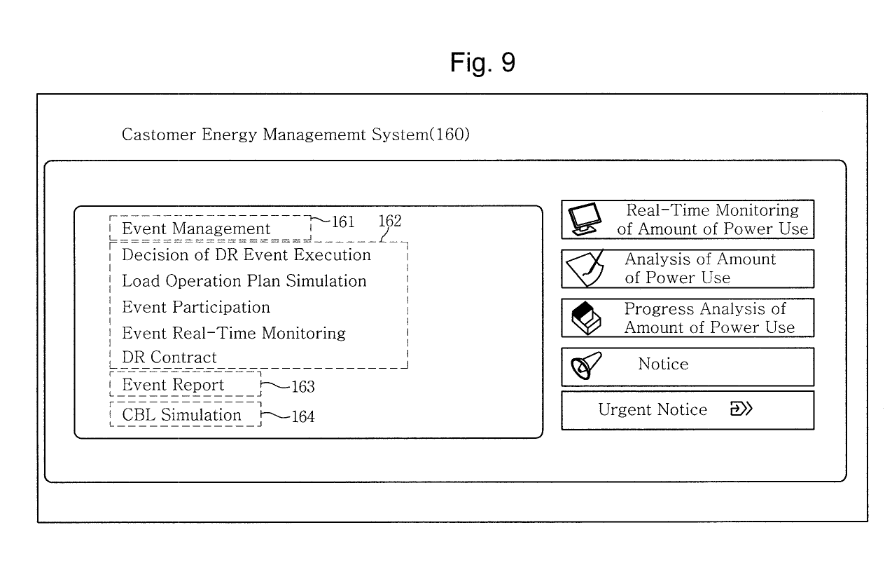

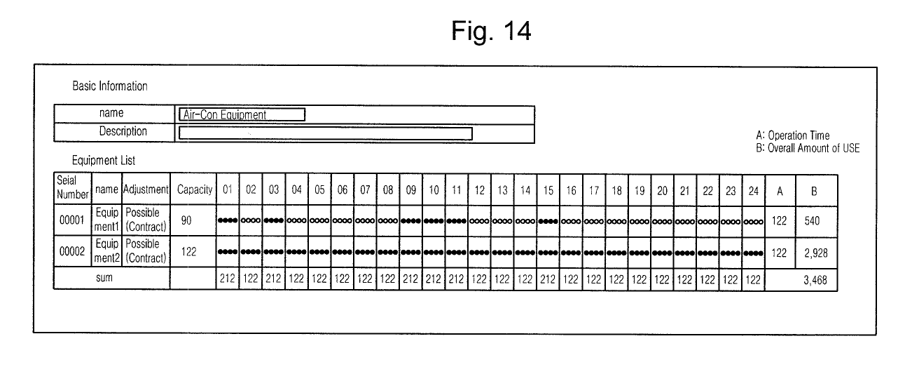

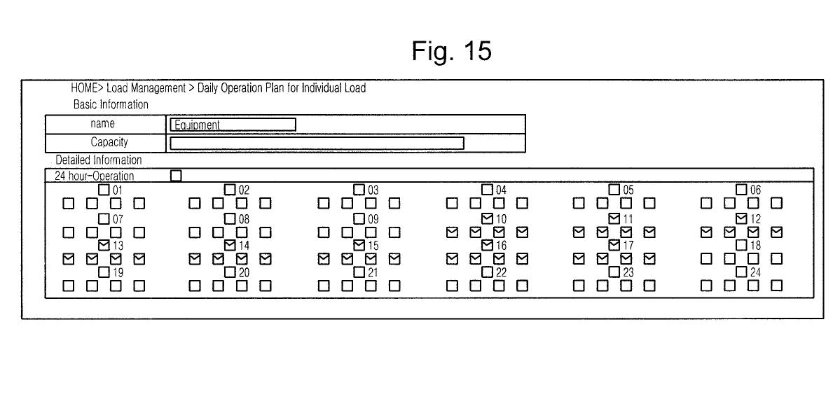

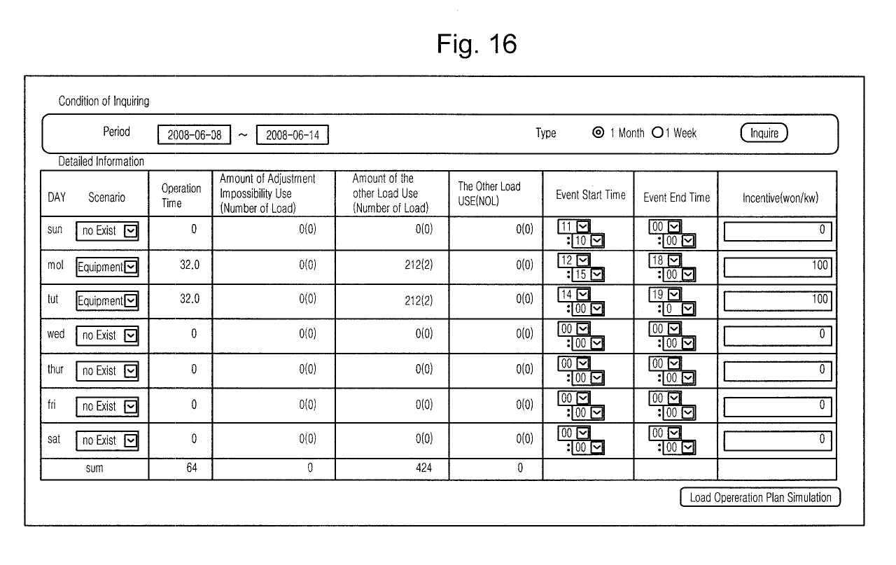

FIG. 1 is a block diagram of a day-ahead load reduction system 100 based on a customer baseline load according to an embodiment of the present invention, FIG. 2, FIG. 4, and FIGS. 6 through 8 are exemplary views for showing the function of a demand response operation system illustrated in FIG. 1, FIG. 3 is a flow chart for showing application and approval for the DR event, FIG. 5 is a flow chart for showing the demand response operation and the energy management system, and FIGS. 9 through 15 are exemplary views for showing the function of customer energy management system illustrated in FIG. 1.

Referring to FIG. 1, the day-ahead load reduction system 100 based on a customer baseline load according to an embodiment of the present invention includes an advanced metering infrastructure (AMI)/automatic metering reading (AMR) translator 110, a meter data management system 120, a demand response operation system 130, a load forecasting analysis system interface 140, an energy information (EI) agent interface 150, a customer energy management system 160, and a demand response (DR) event account system 170. The day-ahead load reduction system 100 based on a customer baseline load can operate in connection with a provider terminal (not shown) and a user terminal (not shown) through a network to induce a reduction in the load of a user (customer). Here, the provider terminal may be a terminal of an electric power provider (electric power corporation) and the user terminal may be a terminal of a user (customer) provided with electric power. A load may be the amount of electric power used for a predetermined time, for example, fifteen minutes.

Specifically, the AMI/AMR translator 110 collects load profile data of a user (customer) from an AMI/AMR system (not shown) in real time, for example, every fifteen minutes, converts the collected load profile data and stores the converted load profile data in a meter data warehouse 115 corresponding to a large-capacity database (DB). The load profile data stored in the meter warehouse 115 is used for load analysis of the day-ahead load reduction system 100 based on a customer baseline load, real-time monitoring, result and settlement of a day-ahead load reduction event. The AMI/AMR system is used for the provider (electric power corporation) to remotely automatically meter electric power used by a user (customer) and provide services such as accurate power supply and charging and report. In the current embodiment of the invention, the day-ahead load reduction event corresponds to a load reducing event provided by the electric power provider. The user (customer) can have an incentive (customer compensation per kW of a load reduction) through the day-ahead load reduction event.

The meter data management system 120 synthetically manages the load profile data of the meter data warehouse 115 in real time. That is, the meter data management system 120 monitors the load profile data of the meter data warehouse 115, performs trend analysis for the amount of used electric power of the user (customer) from the load profile data, grasps and analyzes demand property of each group, constructs a market-oriented demand management standardization method and a command data reference model which employs a common information model (CIM) and is applied to the day-ahead load reduction system 100 based on a customer baseline load and constructs a common exchange data bus commonly used with a power associated upper and lower systems to provide a cooperative utilization base.

The demand response operation system 130 performs overall management for effectively operating the day-ahead load reduction system 100 based on a customer baseline load.

FIG. 2 is an embodiment for the demand response operation system 130 realized in a graphic user interface. Referring to FIG. 2, the demand response operation system 130 may include a DR customer management 131, a DR event management 132, a DR event execution management 133, and a DR event analysis and validation management 134. That is, the demand response operation system 130 manages the demand of the user (customer) by using the load profile data and performs overall management, analysis and verification of a day-ahead load reduction event. That is, the demand response operation system 130 processes and manages sign-up through a contract with a user (customer) who will participate in the day-ahead load reduction event, registers and notifies the day-ahead load reduction event, executes the notified day-ahead load reduction event, monitors and analyzes the status of participation of the user (customer) in the day-ahead load reduction event which is being executed, and performs overall effect analysis and verification on an ended day-ahead load reduction event.

The DR customer management 131 manages the contract of the user (customer) participating in the day-ahead load reduction event and operation of procedures. Specifically, the DR customer management 131 registers and manages customers joining in the day-ahead load reduction event, inquires into the status of joining in the day-ahead load reduction event and analyzes the joining status. Here, the function of registering and managing customers joining in the day-ahead load reduction event includes a sign-up procedure of confirming and approving sign-up information of a user (customer) joining through the customer energy management system 160 using a user terminal (not shown). Referring to FIG. 3, a customer may decide whether to participate in an event after simulating a CBL. When she/he decides to participate, she/he may apply for joining. An electric power provider may confirm and approve after examining the application.

Furthermore, the DR customer management 131 performs comparison and analysis of overall electric power resources and day-ahead load reduction resources by administrative districts to check the status of joining of users (customers) who will participate in the day-ahead load reduction event. An embodiment for these functions is shown graphically in FIG. 4 realized in a GUI. Here, overall status and status for branch are presented related with the number of customers, contract power, DR power, and so on.

Referring to FIG. 5, the DR event management 132 registers the day-ahead load reduction event which will be executed and notifies the user of the day-ahead load reduction event by using the user terminal (not shown) through the customer energy management system 160. Furthermore, the DR event management 132 registers a new day-ahead load reduction event, inquires into the status of participation of users (customers) in the registered new day-ahead load reduction event, analyzes the status of participation of users (customers) in a day-ahead load reduction event which is being executed and analyzes the status of participation of users (customers) in an ended day-ahead load reduction event. Here, the registered new day-ahead load reduction event may be displayed on a day-ahead load reduction event image of the user terminal or the provider terminal through mail or a short message service function right after the new day-ahead load reduction event is registered.

The DR event execution management 133 executes the registered day-ahead load reduction event and manages the execution of the day-ahead load reduction event. the DR event execution management 133 monitors and analyzes the execution of the day-ahead load reduction event of users (customers) participating in the day-ahead load reduction event in real time and analyzes the status of participation of the users (customers) by administrative districts, contract power and class of contract of the participating users.

An embodiment for these functions is shown graphically in FIGS. 6 and 7 realized in a GUI. Referring to FIG. 6, inquiring into event participation intention for each classification of branch, industry and contract to be analyzed and the analysis result are presented in a graphical manner. Referring to FIG. 7, the number of DR customers related with branches and the result for an event are presented.

The DR event analysis and validation management 134 analyzes and validates the effect of the day-ahead load reduction event. That is, the DR event analysis and validation management 134 analyzes and validates the effect of the ended day-ahead load reduction event, compares the actual amount of electric power used with a customer baseline load by administrative districts, class of contract and contract power of participating users (customers), analyzes the comparison result, and synthetically manages CO₂ reduced emission and a reduction with respect to use of electric power. An embodiment for these functions is shown graphically in FIGS. 6 and 7 realized in a GUI. Referring to FIG. 8, an event participation effect analysis and the result are presented.

The load forecasting analysis system interface 140 operates in connection with a day-ahead load forecasting analysis system (not shown) which executes the day-ahead load reduction event, analyzes the effect of the day-ahead load reduction event and calculates a customer baseline load that will be applied to settlement in the demand response operation system 130 to provide the customer baseline load to the demand response operation system 130.

The EI agent interface 150 provides energy data from an EI agent system (not shown) which performs scheduling for collecting the energy data from various different types of networks and systems, extraction, conversion, loading and management of extract transform load (ETL) to the demand response operation system 130 in real time.

Referring to FIG. 9, the customer energy management system 160 is presented in a GUI display window to operate in connection with the demand response operation system 130 and perform a function of allowing a user (customer) who is a contractor of the day-ahead load reduction event to self-control use of electric power. That is, the customer energy management system 160 provides real-time power usage information and incentive information to the user (customer) to induce the user (customer) to efficiently consume electric power.

Furthermore, the customer energy management system 160 performs a load operation plan simulation for joining in a day-ahead load reduction event, participation in the day-ahead load reduction event, real-time monitoring of the day-ahead load reduction event, analysis of the effect of participation in the day-ahead load reduction event after the day-ahead load reduction event is ended, and efficient application of the load of a user.

Specifically, the customer energy management system 160 may include a DR event management 161, an event processor 162, an event analyzer 163 and a load operating simulation 164. The event processor 162 includes a decision of DR event execution, a load operation plan simulation, an event participation and real-time monitoring of event. And the event analyzer 163 corresponds to an event report. And the load operating simulation 164 corresponds to a CBL Simulation.

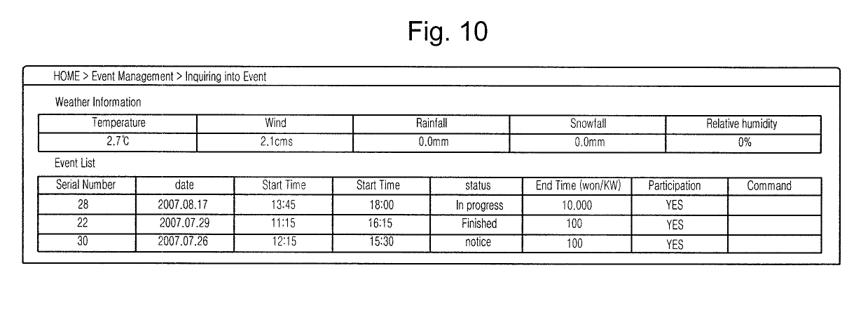

The event management 161 makes a contract of a day-ahead load reduction event, approves the agreement of the contract, manages facility information, determines whether the day-ahead load reduction event is executed and inquires into the history of the day-ahead load reduction event. Referring to FIG. 10, the event management 161 is presented to inquire into the history the day-ahead load reduction event in connection with a DR operating system, and performs inquiries into an event date for an event, start time, end time, status, incentive and participation. When a serial number is selected, the present event branches into an event processor while the ended event branches into event analysis.

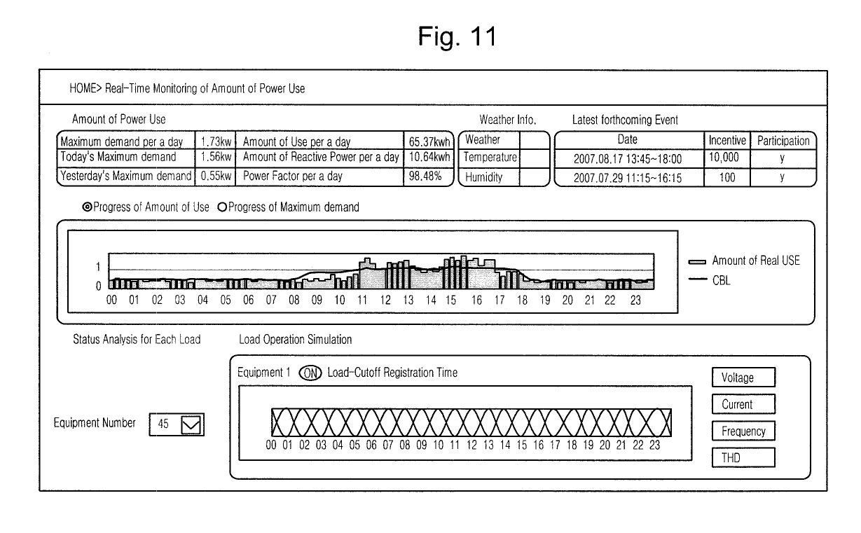

Referring to FIG. 11, the event processor 162 is presented to monitor the execution of the day-ahead load reduction event which is noticed by the customer energy management system in real time. Accordingly, the user (customer) can be aware of real-time maximum demand, the amount of use, the amount of reactive power, power factor, and so on and can be aware of weather information, participation for forthcoming event. Comparing the amount of power use and the process of maximum demand, analyzing in reference with the actual amount of use and CBL, and downloading in the form of EXCEL can be performed.

And the event processor can perform the analysis of status of registered equipments, and set a registration time for load cutoff and do ON/OFF function for a load equipment. Furthermore, the event processor 162 can allow the user (customer) to monitor the voltage, current, frequency and total harmonics distortion (THD) of the load facility in real time through the user terminal.

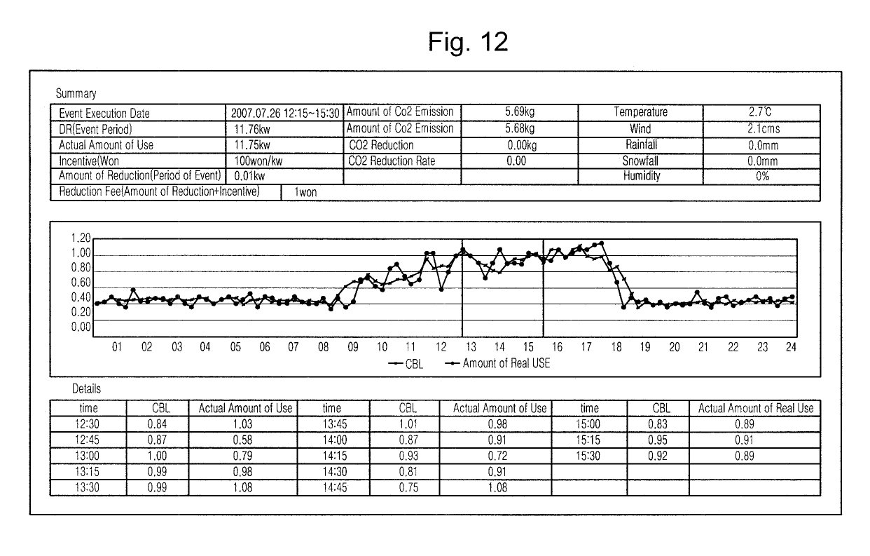

Referring to FIG. 12, the event analyzer 163 is presented to analyze the effect of participation in the day-ahead load reduction event executed by the customer energy management system 160. Furthermore, the event analyzer 163 provides the event execution date, the customer baseline load for an event period, the actual amount of use for an event period, the incentive, the amount of load reduced, the incentive by the reduction, CO₂ emission in an event period for the actual amount of use, CO₂ emission based on a CBL in an event period, reduced CO₂, reduction rate for the CO₂ emission based on a CBL, and weather information. And it provides the data using the graph so that any user can see the information on a CBL and the amount of actual use easily, and it also provides the function by text mode.

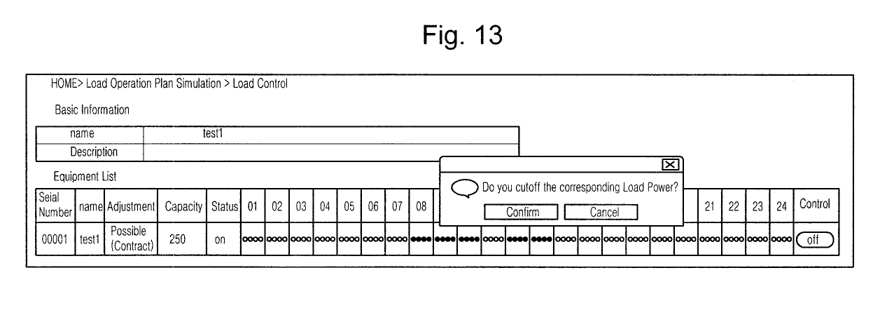

Referring to FIGS. 13 through 16, the load operating simulation 164 is presented to perform load facility management, load operating scenario management, daily load operating plan establishment, weekly/monthly load operating plan management, and load operating plan simulation, to establish and to manage a facility operating plan at predetermined intervals according to power facility operating status of the user (customer) for the registered load facility.

The DR event account system 170 operates in connection with the demand response operation system 130 and the customer energy management system 160, performs settlement to which power market price and an incentive is applied for a reduction in electric power used as a result of the day-ahead load reduction event, calculates an incentive for the result of the day-ahead load reduction event, notifies the provider (electric power corporation) and the user (customer) of the calculated incentive through the provider terminal and the user terminal, and manages demand by events, administrative districts, class of contract and contract power.

As described above, the day-ahead load reduction system 100 based on a customer baseline load according to the embodiment of the present invention applies an incentive (user compensation according to load reduction) to control the load of a user at regular times, and thus the user can be induced to perform efficient energy consumption management.

According to the day-ahead load reduction system 100 based on a customer baseline load according to the embodiment of the present invention, a provider (electric power corporation) can reduce purchase electric power price due to a drop in the wholesale power price caused by a load reduction and a user (customer) can cost-flexibility consume electric power through the incentive, change the habit of using electric power at the power peak and reduce power consumption.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A day-ahead load reduction system based on a customer baseline load, which operates in connection with a provider terminal and a user terminal through a network to induce a reduction in the load of a user, comprising:
an AMI/AMR translator collecting load profile data of the user in real time, converting the load profile data and storing the load profile data in a meter data warehouse;
a meter data management system monitoring and analyzing the load profile data stored in the meter data warehouse in real time;
a demand response operation system managing the demand of the user by using the load profile data and performing overall management, analysis and verification of a day-ahead load reduction event;
a customer energy management system operating in connection with the demand response operation system and providing information on the load to the user through the user terminal in real time to allow the user to control the load; and
an account system operating in connection with the demand response operation system and the customer energy management system, calculating an incentive for the day-ahead load reduction event and notifying a provider and the user of the incentive through the provider terminal and the user terminal.

2. The day-ahead load reduction system based on a customer baseline load of claim 1, wherein the load corresponds to the amount of electric power used, the day-ahead load reduction event is an event regarding a reduction in the load, which is provided by the provider, and the incentive corresponds to compensation per kW of the load reduction, which is provided to the user.

3. The day-ahead load reduction system based on a customer baseline load of claim 2, wherein the demand response operation system comprises:
a demand response (DR) customer management managing a contract of a user who will participate in the day-ahead load reduction event and operation of a procedure;
a DR event management registering the day-ahead load reduction event and notifying the user of the day-ahead load reduction event in advance by using the user terminal;
a DR event execution management executing the day-ahead load reduction event and managing the execution of the day-ahead load reduction event; and
a DR event analysis and validation management performing analysis and validation on the effect of the day-ahead load reduction event.

4. The day-ahead load reduction system based on a customer baseline load of claim 3, wherein the DR customer management performs comparison and analysis of day-ahead load reduction resources and the overall power resources by administrative districts for the status of joining of users in the day-ahead load reduction event.

5. The day-ahead load reduction system based on a customer baseline load of claim 3, wherein the DR event management registers a new day-ahead load reduction event, inquires into the status of participation of users in the registered new day-ahead load reduction event, analyzes the status of participation of users in a day-ahead load reduction event that is being executed, and performs analysis of the effect of user's participation in an ended day-ahead load reduction event.

6. The day-ahead load reduction system based on a customer baseline load of claim 3, wherein the DR event execution management monitors and analyzes the execution of the day-ahead load reduction event of the user in real time and analyzes the status of participation of the user for the administrative district, contract power and class of contract with respect to the user.

7. The day-ahead load reduction system based on a customer baseline load of claim 3, wherein the DR event analysis and validation management analyzes and verifies the effect of the ended day-ahead load reduction event to perform comparison and analysis of the customer baseline load and the actual amount of electric power used by administrative districts, classes of contract and contract power of users participating in the day-ahead load reduction event and synthetically manage CO₂ reduced emission and a reduction with respect to the use of electric power.

8. The day-ahead load reduction system based on a customer baseline load of claim 2, wherein the customer energy management system comprises:
an event management performing contract, agreement approval, facility information management and history inquiry with respect to the day-ahead load reduction event and determining whether the day-ahead load reduction event is executed;
an event processor approving participation in the notified day-ahead load reduction event and performing real-time monitoring;
an event analysis analyzing the effect of participation in the executed day-ahead load reduction event; and
a load operating simulation performing load facility management, load operating scenario management, establishment of a daily load operating plan, management of weekly/monthly load operating plans, and a load operating plan simulation.

9. The day-ahead load reduction system based on a customer baseline load of claim 8, wherein the event processor monitors CO₂ reduced emission and a reduction with respect to the use of electric power, the change in maximum acceptance and the change in the amount of electric power used by loads, controls a selected load facility according to a load operating plan of the user through the user terminal, and monitors the voltage, current, frequency, total harmonics distortion (THD) of the load facility.

10. The day-ahead load reduction system based on a customer baseline load of claim 8, wherein the event analysis provides the customer baseline load, the amount of electric power reduced, the incentive, CO₂ reduced emission with respect to the use of electric power and weather information to the user through the user terminal during the day-ahead load reduction event and performs comparison and analysis of the customer baseline load and the actual amount of electric power used at predetermined intervals.

11. The day-ahead load reduction system based on a customer baseline load of claim 8, wherein the load operating simulation establishes and manages a facility operating plan according to the power facility operating status of the user for the registered load facility.

12. The day-ahead load reduction system based on a customer baseline load of claim 1, further comprising a load forecasting analysis system interface operating in connection with a day-ahead load forecasting analysis system which executes the day-ahead load reduction event, analyzes the effect of the day-ahead load reduction event and calculates a customer baseline load that will be applied to settlement to provide the customer baseline load to the demand response operation system.

13. The day-ahead load reduction system based on a customer baseline load of claim 1, further comprising an energy information agent interface providing energy data from an energy information agent system which performs scheduling for collecting the energy data from different types of networks and systems, extraction, change, loading and management of an extract transform load (ETL) to the demand response operation system in real time.
